(19) United States
(12) Patent Application Publication
(10) Pub. No.: US 2019/0163695 A1
(43) Pub. Date: May 30, 2019

(54) METHOD AND SYSTEM FOR ASSISTING RESEARCHERS TO PERFORM RESEARCH, TO MANAGE REFERENCED SOURCES, AND TO GENERATE RESEARCH DOCUMENTS

(71) Applicant: Charles Arthur Castleberry, Sandy, UT (US)

(72) Inventor: Charles Arthur Castleberry, Sandy, UT (US)

(21) Appl. No.: 16/199,638

(22) Filed: Nov. 26, 2018

Related U.S. Application Data
(60) Provisional application No. 62/590,462, filed on Nov. 24, 2017.

(51) Int. Cl. G06F 16/38; G06F 16/338; G06F 16/953; G06F 16/583

(52) U.S. Cl. CPC G06F 16/382; G06F 16/5846; G06F 16/953; G06F 16/338

(57) ABSTRACT

A method and system provide a research assistance system that includes a research assistance application. The research assistance application assists users to generate research documents. The research assistance application assists users to retrieve reference material from reference sources and to incorporate the reference material into the research document. The research assistance application automatically handles citations and generates an accurate bibliography based on the reference materials.

### CROSS REFERENCE TO RELATED APPLICATION

The present application claims priority benefit from U.S. provisional patent application No. 62/590,462, filed on Nov. 24, 2017, titled “Personal Research Assistant System”, attorney docket number 24004-01-01. U.S. provisional patent application No. 62/590,462 is incorporated herein by reference in its entirety.

### BACKGROUND

Every year, millions of people perform research for various reasons. For example, high school and university students are required to perform research and to write research papers on selected topics. Scientists of all kinds research various sources and write scientific papers to be submitted to scientific journals. Historians perform research among historical documents in order to write articles or books on historical topics. Many other types of individuals and groups also perform research in order to produce written documents of various types.

Typically, producing a research document includes seeking out information from many sources. These sources may be directly quoted in the research document, referred to in the research document, or merely used as background for the writer. Researchers often undertake great effort to organize and keep track of the various sources and materials that they have located in their research efforts.

Furthermore, researchers typically must include a bibliography in the research documents that they produce. Each source quoted or otherwise referred to in the research document must be cited in the bibliography. Additionally, the sources cited in the bibliography must be listed in accordance with an established format. During the writing and editing process, quotes and references to source material are frequently moved, reordered, or deleted. Researchers make painstaking effort to ensure that the bibliography is updated to properly reflect the sources referred to and the order in which the sources are referred to.

In spite of the great efforts undertaken by researchers to generate and maintain an accurate bibliography, researchers often make errors in the bibliography. Errors in the bibliography can have tremendous adverse real-world consequences for researchers. Failure to properly cite sources can result in negative consequences during peer review, failure to have a research document published, embarrassment after publishing, or even accusations of malfeasance.

To overcome these difficulties, researchers often hire research assistants to assist them in the task of identifying sources and maintaining accurate bibliographies. In other cases, researchers look to traditional word processing systems to assist in managing sources and bibliographies during the process of generating research documents. These solutions are often very expensive and very ineffective. It is expensive to pay research assistants who themselves are fallible. Furthermore, traditional word processing systems typically utilize large amounts of computing resources while still failing to make the research process simpler and more accurate.

Accordingly, there exists a technical problem of providing a system that is able to assist researchers and writers in the process of performing research, generating research documents, and maintaining accurate bibliographies. What is needed is a system and method that can provide a technical solution to the technical problem of providing a system that is able to assist researchers and writers in the process of performing research, generating research documents, and maintaining accurate bibliographies.

### SUMMARY

Embodiments of the present disclosure provide one or more technical solutions to the technical problem of providing a system that is able to assist researchers and writers in the process of performing research, generating research documents, and maintaining accurate bibliographies. Embodiments of the present disclosure provide a research assistance system that assists users to perform research, to generate a research document, and to maintain a complete and accurate bibliography from a single research assistance application. Embodiments of the present disclosure provide a research assistance application that enables users to search among databases, to select material from sources identified in the search, and to incorporate the material into a research document. When material is selected from a source identified during research, the research assistance system automatically captures citation metadata identifying the source of the material. When the material is quoted or referred to in the research document, the research assistance system automatically updates a bibliography citing the source of the material. As the user shifts quotes and references, adds new quotes or references, and deletes old quotes or references, the research assistance application automatically updates the bibliography to accurately reflect the sources referenced in the research document.

Embodiments of the present disclosure address some of the shortcomings associated with traditional methods for performing research and generating research documents. A research assistance system in accordance with one or more embodiments enables users to perform research, manage sources and citations, and generate research documents all from a single research assistance application. A research assistance system in accordance with one or more embodiments greatly improves the efficiency with which individuals can perform research and generate research documents.

### BRIEF DESCRIPTION OF THE DRAWINGS

FIG. 1 is a block diagram of a system for assisting researchers to perform research and generate research documents, in accordance with one embodiment.

FIG. 2 is a view of a graphical user interface of a research assistance application provided by a research assistance system.

FIG. 3 is a view of a home page of a research assistance application, according to one embodiment.

FIG. 4 is a flow diagram of a process for assisting researchers to perform research and generate research documents, in accordance with one embodiment.

FIG. 5 is a flow diagram of a process for assisting researchers to perform research and generate research documents, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

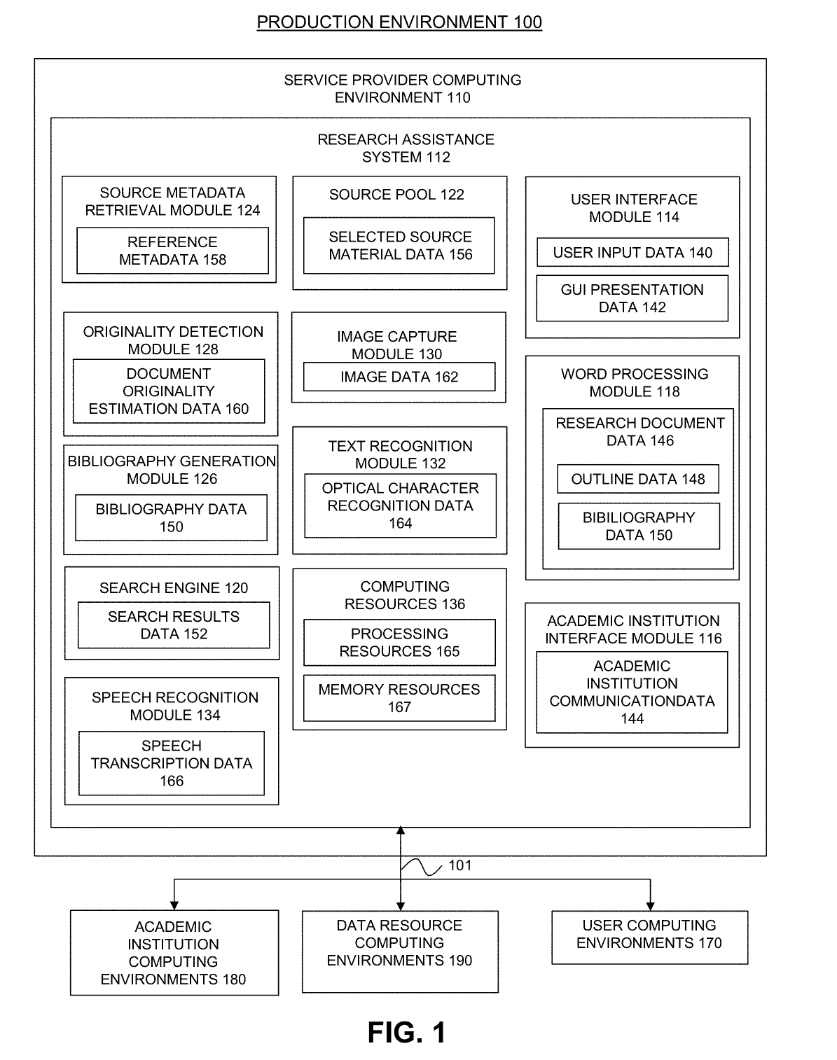

FIG. 1 illustrates a block diagram of a production environment 100 for assisting researchers to perform research and generate research documents, according to one embodiment. Embodiments of the present disclosure provide a research assistance system that streamlines and automates the processes of performing research and generating research documents from the research. The research assistance system provides a research assistance application that users can access from any of their computing devices. The research assistance application provides functionality for users to search among databases and to generate research documents. Researchers can collect, with the research assistance application, a pool of reference material from various sources and can incorporate the reference materials into a research document. Because the research assistance application performs all of the functions of searching among databases, maintaining the pool of reference material, and providing word processing resources for generating research documents, the research assistance application is able to automate the process of generating and maintaining an accurate bibliography for the research document.

In one embodiment, the research assistance system assists users to generate research documents. The research documents can include research papers for school assignments, Masters theses, PhD dissertations, academic articles to be published in academic journals, books, genealogical research documents, and any other types of documents for which research is performed and reference materials are gathered from various sources. The research assistance system can assist individuals to perform research and generate these various types of research documents all from a single research assistance application. As users incorporate research material into a research document, the research assistance application automatically generates and maintains an accurate bibliography.

In one embodiment, because the research assistance system combines research and word processing capabilities into a single application, the research assistance system greatly improves the efficiency with which research can be performed and research documents can be generated. A research assistance application in accordance with embodiments of the present disclosure reduces the amount of effort required to maintain a pool of identified source material, to incorporate the identified source material into a research document, and to maintain an accurate and proper bibliography. The research assistance application thereby greatly reduces the tedium and opportunities for error associated with generating research, writing research documents, and maintaining accurate and proper bibliographies.

The disclosed method and system for assisting researchers to perform research and generate research documents provides for significant improvements to the technical fields of data processing, data management, data transmission, data collection, word processing, and user experience.

In addition, as discussed above, the disclosed method and system for assisting researchers to perform research and generate research documents provides for the processing and storing of smaller amounts of data, i.e., to more efficiently gather research material from a variety of sources and incorporate the research material into research documents. Consequently, using the disclosed method and system for assisting researchers to perform research and generate research documents results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for assisting researchers to perform research and generate research documents.

The production environment 100 includes a service provider computing environment 110, user computing environments 170, and academic institution computing environments 180, and data resource computing environments 190 for assisting researchers to perform research and generate research documents, according to one embodiment. The computing environments 110, 170, 180, and 190 are communicatively coupled to each other with one or more communication channels 101, according to one embodiment.

The service provider computing environment 110 represents one or more computing systems such as a server, a cloud computing environment, a distribution center that is configured to receive, execute, and host one or more research assistance systems (e.g., applications) for access by one or more users, for providing research assistance to users of the research assistance system, according to one embodiment. The service provider computing environment 110 can represent a traditional data center computing environment, a virtual asset computing environment (e.g., a cloud computing environment), or a hybrid between a traditional data center computing environment and a virtual asset computing environment, according to various embodiments. The service provider computing environment 110 can include computing resources associated with user computing devices, cloud-based computing environments, servers, or other computing resource configurations.

The service provider computing environment 110 includes a research assistance system 112, which is configured to provide research assistance to users. The service provider computing environment 110 includes one or more processors configured to execute software instructions stored on one or more computer readable media to provide the functionality of the research assistance system 112, according to one embodiment.

According to one embodiment, the research assistance system 112 is a standalone system that provides research assistance services to users. Alternatively, the research assistance system 112 is integrated into other software or service products provided by a service provider.

In one embodiment, the research assistance system 112 assists users to perform research and to generate research documents based on the research that was performed. The research assistance system 112 provides a research assistance application that users can access via the user computing environments 170 to perform research and to generate research documents. The research documents can include one or more of research papers or essays for school assignments, academic papers for academic journals, books, scientific articles, genealogical studies, or other types of research documents.

As a specific example, in one embodiment, the research assistance system 112 includes a user interface module 114, an academic institution interface module 116, a word processing module 118, the search engine 120, a source material pool 122, a source metadata retrieval module 124, a bibliography generation module 126, an originality detection module 128, an image capture module 130, a text recognition module 132, a speech recognition module 134, and computing resources 136, according to various embodiments.

In one embodiment, the user computing environments 170 include computing environments utilized by users to access the research assistance system 112. For example, the user computing environments 170 can include one or more of a smart phone, a tablet, a laptop computer, a desktop computer, or other kinds of computing devices used by individuals. Users can access, via the user computing environments 170, a research assistance application provided by the research assistance system 112. The research assistance application can be installed on one or more computing devices of the user, such as a smart phone, tablet, laptop computer, or desktop computer. Thus, some of the functionality and modules associated with the research assistance system 112 and described herein related to the research assistance system 112 can be installed and implemented within the user computing environments 170, while other aspects of the research assistance system 112 may be installed or implemented within computing environments remote from the user computing environments 170.

In one embodiment, the research assistance system 112 interfaces with academic institution computing environments 180. Academic institutions can have accounts with or otherwise be associated with the research assistance system 112. Students or faculty of the academic institutions can use the research assistance system 112 as part of their association with the academic institutions. The research assistance system 112 gathers data from the academic institutions via the academic institution computing environments 180. The data can include, for each student, a list of classes currently being taken by the student, a list of research projects assigned to the student, and other data related to the academic workload of the students. Students can submit research papers or other assignments directly from the research assistance system 112 to the academic institution computing environments 180, by which teachers or professors receive the research papers or other assignments from students. Likewise, faculty of the academic institutions can provide data to students related to assignments and projects and can monitor the progress the students are making on various projects and assignments. Accordingly, the research assistance system 112 communicates with academic institution computing environments 180 to facilitate these functions.

In one embodiment, the research assistance system 112 communicates with data resource computing environments 190. The data resource computing environments 190 can include computing environments associated with databases of research resources. Such database resources can include online databases for academic journals, encyclopedias, libraries, websites, newspapers, magazines, and other sources within which researchers may perform research via the research assistance system 112. In other words, the research assistance system 112 can connect with data resource computing environments 190 to enable researchers to perform research among the databases associated with the data resource computing environments 190.

In one embodiment, the research assistance system 112 includes a user interface module 114. The user interface module 114 enables users to access the functionality of the research assistance system 112. In particular, the user interface module 114 connects with user computing environments 170 in order to enable users to communicate with the research assistance system 112. Aspects of the user interface module 114 may be installed within the user computing environments 170.

In one embodiment, the user interface module 114 presents a graphical user interface by which users access the functionality of the research assistance system 112. The graphical user interface can present text, images, graphics, video, and audio to users of the research assistance system 112. The users can interact with the graphical user interface to provide information to the research assistance system 112 and to receive information from the research assistance system 112. Accordingly, the graphical user interface provides the functionality by which users can communicate with the research assistance system 112.

In one embodiment, users provide user input data 140 to the user interface module 114. The user input data 140 can include search queries provided by the user to the research assistance system 112. When the user provides a search query to the research assistance system 112, the research assistance system 112 provides a search among one or more selected databases to retrieve source material for the user in accordance with the search terms of the search query.

In one embodiment, the user input data 140 can include data entered by users to be incorporated into research documents. A user may utilize the research assistance system 112 the generator research document. The user input data 140 can include the data to be incorporated into the research document. Accordingly, the user input data can include text, audio, images, graphics, or video provided by the user to be incorporated into a research document.

In one embodiment, the user data 140 includes any commands or data provided by the user to the research assistance system 112. The user data 140 can include text typed by the user, selections made by the user, or data otherwise entered by users to communicate in any way with the research assistance system 112.

In one embodiment, the user interface module 114 presents graphical user interface (GUI) presentation data 142 to the users. The GUI presentation data 142 can include any data presented to the user by the research assistance system 112. The GUI presentation data 142 can include text, images, graphics, audio, video, or any other presentational tools by which data can be communicated to the user or by which the research assistance functionality can be provided to the user. The user can interact with the GUI presentation data 142 in order to interface with the research assistance system 112.

In one embodiment, the research assistance system 112 includes an academic institution interface module 116. The academic institution interface module 116 interfaces with academic institutions in order to enable academic institutions to access the services of the research assistance system 112 and to enable the research assistance system 112 to access the academic institutions. As set forth above, academic institutions can have general accounts with the research assistance system 112 in accordance with agreements made between the academic institutions and the research assistance system 112. These agreements enable faculty and students of the academic institutions to utilize the research assistance system 112 to perform research and generate research documents.

In one embodiment, the academic institution interface module 116 receives or retrieves academic institution communication data 144 from the academic institutions via the academic institution computing environments 180. The academic institution communication data 144 can include any data accessible by students or faculty members that have an account with the research assistance system 112. The academic institution communication data 144 can include any data provided by or received from the academic institution computing environments 180.

In one embodiment, the academic institution communication data 144 can include current academic course data of students of academic institutions. The current academic course data can include class schedules of students, as well as assignments or projects currently assigned to students for each class. Students can access the current academic course data via the research assistance system 112 in order to see what assignments or projects have been assigned for each class. The current academic course data can include instructions or rubrics associated with each assignment or project.

In one embodiment, the academic institution communication data 144 can include data retrieved from academic databases associated with academic institutions. For example, when an academic institution has an account with the research assistance system 112, students at the academic institution can utilize the research assistance system 112 to access research databases associated with the academic institution. The academic institution communication data 144 can include data retrieved from the research databases associated with the academic institution. Such research databases can include electronically accessible libraries, journals, or collections associated with the academic institutions.

In one embodiment, the research assistance system 112 includes a word processing module 118. The word processing module 118 provides word processing functionality to users of the research assistance system 112. The word processing functionality provided by the word processing module 118 enables users to generate research documents via the research assistance system 112.

In one embodiment, when a user utilizes the research assistance system 112 to prepare a research document, the word processing module 118 generates research document data 146 corresponding to the research document. The word processing module 118 enables users to type or otherwise provide text to be included in the research document. The word processing module 118 enables users to create, edit, and revise documents in accordance with the functionality commonly provided by traditional word processing applications. The word processing module 118 can enable users to add new text, revise text, or undo changes in a research document. The word processing module 118 can enable users to select text or document formats, select fonts, select text styles, to select text colors, text select text effects such as bold, underline. The word processing module 118 can enable users to copy and paste text or images. The word processing module 118 can enable users to cut and paste text or images, to select text colors, and to select text effects such as bold, underline, and italics. The word processing module 118 can enable users to perform many other word processing functions provided by traditional word processing applications, in accordance with various embodiments.

In one embodiment, the research document data 146 includes outline data 148. While the user generates the research document, the research document data 146 can include an outline as indicated in the outline data 148. The outline data 148 can define various sections of the research document. The user can quickly and conveniently navigate between various sections of the research document by selecting sections in the outline data 148. Various sections in the outline can correspond to particular research references identified and used by the user.

In one embodiment, the research document data 146 includes bibliography data 150. The bibliography data 150 includes, for each portion of the research document that is based on source material or includes a quote from source material, a citation to the source. A citation can include a reference to one or more of a title, an author, a date, a webpage, or any other identifying information associated with a source from which information was utilized to generate the research document.

In one embodiment, the word processing module 118 automatically generates the bibliography data 150. As will be set forth in more detail below, as a user gathers research material from sources via the research assistance system 112, the research assistance system 112 automatically retrieves and stores citation data for each source. As the user incorporates the research material into the research document, the word processing module 118 automatically generates bibliography data for the cited sources. As the user adds, removes, or shifts the positions of various research material within the research document, the word processing module 118 automatically updates the bibliography data 150.

In one embodiment, the research assistance system 112 includes a search engine 120. The search engine 120 enables users of the research assistance system 112 to search among databases for sources to utilize in generating research documents. When users access the research assistance application, users are able to perform a search from within the research assistance application. This reduces the need for users to access other applications, such as web browsers or other programs, to perform searches.

In one embodiment, users that utilize the search engine 120 can perform searches in any database for which the users have access credentials. If a user accesses the research assistance system 112 under the umbrella of an academic institution with which the user is associated, then the search engine 120 can perform searches in any databases for which the academic institution has access credentials. For example, the search engine 120 will have access to internal library databases associated with the academic institution. Users can search within these databases from the search engine 120.

In one embodiment, the user can provide, to the research assistance system 112, access credentials for any databases to which the user has access. The user can provide, via the user interface module 114, access credentials for the various databases to which the user has access credentials. Thereafter, when the user utilizes the search engine 120, the search engine 120 can use the access credentials of the user to search among those databases.

In one embodiment, the search engine 120 can search among any databases for which access credentials are not required. The user can enter a search query into the search engine 120 and the search engine can search among all databases to which the search engine has access. Alternatively, the user can select the databases within which the user would like the search engine 122 perform a search.

In one embodiment, when the user enters a search query into the search engine 120, the search engine performs a search in the selected database or databases and generates search results data 152. The search results data 152 include the results that the search engine has generated based on the search terms provided by the user. The search results data 152 can include a list of references that are relevant to the search query terms. The search results data 152 can also include snippets of the relevant text for each reference in the list of references. The user can then select, from the list of references, those references that the user would like to view in more detail.

In one embodiment, the reference assistance system 112 includes a source pool 122. The source pool 122 includes, for each research project of the user, selected source material data 156. The selected source material data 156 includes material selected from references included in the search results data 152 to be used in the research document. Thus, while the user edits the research document data 146 via the research assistance application, the user can select material from the selected source material data 156 to be included, quoted, or otherwise referenced in the research document. The user can select a portion of reference material and then select a location within the outline data 148 of the research document data 146 at which the selected material will be quoted or referenced. In one embodiment, reference material selected by the user from a search will automatically be imported into the research document.

In one embodiment, when the user selects a reference from the search results data 152 to view in more detail, the research assistance application prompts the user to indicate whether the user would like to add the reference to the research document source pool 122 for the research document. If the user selects to add the reference to the research document pool 122 for the research document, then the reference is added to the source pool. Alternatively, or additionally, selected material is automatically imported into the research document.

In one embodiment, the research assistance system 112 includes a source metadata retrieval module 124. Whenever a new reference or source is added to the source pool 122 for a research project or research document, the source metadata retrieval module 124 retrieves reference metadata 158 identifying the reference. The reference metadata 158 can later be used to generate a citation for the reference in the bibliography data 150.

In one embodiment, when a user uses the search engine 120 to search in a database 120, the metadata retrieval module 124 retrieves reference metadata 158 for each reference identified in the search results data 152. Alternatively, the source metadata retrieval module 124 retrieves metadata only for those references that are selected to be included in the source pool 122 for the research document.

In one example in accordance with one embodiment, one of the references in the search results data 152 includes a book. The source metadata retrieval module 124 retrieves reference metadata 158 indicating the title of the book, the author of the book, the publication year of the book, the page of the book identified by the search engine 120 as being relevant to the search results, a catalog number of the book, an edition number of the book, a printing number of the book, a cover type of the book, an international standard book number (ISBN) of the book, and an identification of the database or online library from which the book was retrieved. The reference metadata 150 associated with the book can be utilized by the research assistance system 112 to generate or update a bibliography citation associated with the book.

In one embodiment, one of the references in the search results data 152 includes a journal article. The source metadata retrieval module 124 retrieves reference metadata 158 indicating the title of the article, the authors of the article, the publication date of the article, the edition of the journal in which the article appears, the page of the article identified by the search engine 120 as being relevant to the search results, and an identification of the database or online library from which the book was retrieved. The reference metadata 150 associated with the article can be utilized by the research assistance system 112 to generate or update a bibliography citation associated with the article.

In one embodiment, one of the references in the search results data 152 includes a reference to a website. The source metadata retrieval module 124 includes reference metadata 158 identifying the URL of the website, a time stamp indicating a date and time at which the website was retrieved, and identification of an individual or individuals associated with the website, and any other identifying information related to the website. The reference metadata 158 can be utilized to make a citation to the website in the bibliography data 150.

In one embodiment, the reference metadata 158 cannot be edited by the users of the research assistance system 112. This prevents intentional or unintentional tampering with the reference metadata 150. Bibliography data 150 generated from the reference metadata 158 is much more likely to be accurate because users are unable to make changes to the reference metadata 158 from which the bibliography data 150 is generated.

In one embodiment, the source metadata retrieval module 124 is part of the search engine 120. In other words, the search engine 120 generates or retrieves the reference metadata 158 each time search results data 152 is generated in response to a search query made by a user.

In one embodiment, the source metadata retrieval module 124 is able to supplement the reference metadata 158 when inadequate reference metadata is available via the databases from which the references were found. The source metadata retrieval module 124 is able to search out additional reference metadata related to a reference if the reference metadata available from the database is lacking. In one embodiment, when sufficient reference metadata is not available for reference, the source metadata retrieval module 124 can search among other databases or sources from which the reference may also be available in order to obtain additional reference metadata related to the reference.

In one embodiment, the research assistance system 112 includes an image capture module 130. In some instances, a user of the research assistance system 112 may find reference material in the physical reference. The physical reference may include a physical copy of the book, a physical copy of a journal article, a physical copy of a magazine, a physical copy of a photograph, a sheet of paper, or any other physical reference that includes reference material that the user would like to include or otherwise rely on in the research document. In this case, the research assistance system 112 can utilize the image capture module to capture an image of the physical reference.

In one embodiment, as the user utilizes the research assistance application from a computing device of the user, the research assistance application presents to the user, via the GUI, an option to capture an image of a physical reference. When the user selects the option to capture an image, the image capture module can access the camera associated with the computing device from which the user is accessing the research assistance application. A view finder then appears in the GUI by which the user can find the selected view of the reference. When the user has positioned the reference in a selected manner, the user can select to have the research assistance application capture an image of the physical reference utilizing the camera of the computing device of the user.

In one embodiment, the research assistance application can enable the user to incorporate an image previously captured by the user outside the use of the research assistance application. In this case, the research assistance application can access photographs stored in the computing device of the user. The research assistance application can enable the user to browse through photographs stored in the computing device of the user. The user can then select one or more photographs to be incorporated as reference material in the source pool 122.

In one embodiment, the research assistance application can enable the user to incorporate images stored outside of the computing device of the user. For example, the research assistance application can enable the user to access cloud media storage, other computing devices, or websites in order to obtain photographs to be incorporated into the source pool 122 or to otherwise be incorporated into the research project of the user.

In one embodiment, the research assistance system 112 includes a text recognition module 132. The text recognition module 132 can scan images in order to identify text or other characteristics of the images. The text recognition module 132 generates optical character recognition data 164 corresponding to the text included in the portion of the physical reference captured in the image.

In one embodiment, the research assistance application can incorporate the text from the optical character recognition data 164 captured from one or more images into the selected source material data 156. The user can then incorporate the text into the research document as a quote. Alternatively, the user can otherwise utilize or refer to the text from the optical character recognition data 164 in the research document.

In one example, in accordance with one embodiment, the user captures or otherwise retrieves an image of a particular page of the book to be used as reference material in the research document. The text recognition module 132 analyzes the captured image and generates optical character recognition data 164 corresponding to the text included in the image. The research assistance application then prompts the user to indicate which portion of the text the user would like to import into the source pool 122. Alternatively, before performing optical character recognition analysis on the image, the research assistance application can prompt the user to indicate a portion of the image on which optical character recognition analysis will be performed. The text recognition module 132 will then perform optical character recognition analysis on the selected portion of the image.

In one embodiment, the optical character recognition data is utilized to generate reference metadata from one or more images associated with a physical reference. For example, if the user utilizes a physical book as a reference, the user can capture an image of one or more of the cover of the book, the spine of the book, a title or copyright page of the book, and a page of the book from which reference material will be utilized. The text recognition module 132 then performs optical character recognition analysis on the image or images and generates optical character recognition data 164 corresponding to the text included in the image or images. The source metadata retrieval module 124 can then determine a title of the book, and author of the book, an edition of the book, a page number from which the reference material is taken, or other details related to the book. The source metadata retrieval module 124 can then search among one or more databases in order to retrieve reference metadata 158 associated with the book. The reference metadata 158 can then be utilized in generating the bibliography data 150. Optical character recognition data and reference metadata can be generated similarly for physical references other than books, such as documents, journal articles, newspaper articles, magazines, or other physical references.

In one embodiment, the research assistance system includes a bibliography generation module 126. The bibliography generation module 126 generates the bibliography data 150 based on the reference metadata 158 for the various sources included in the source pool 122. As the user gathers sources into the source pool 122 to be utilized for the research document, the reference metadata 158 for each reference is attached to the reference. When the user incorporates one of the references from the source pool 122 into the research document, the bibliography generation module 126 generates a bibliography entry including a citation to the reference. As the user rearranges or otherwise edits source material in the research document, the bibliography generation module 126 updates the bibliography so that the bibliography continues to be accurate. In one embodiment, the bibliography generation module 126 is part of the word processing module 118.

In one embodiment, the research assistance application prompts the user to select a citation format for the bibliography data 150. The user can select from any common citation formats including, but not limited to, Modern Language Association (MLA) format, American Psychological Association (APA) format, Chicago format, and Bluebook format. When the user selects a citation format, the bibliography data 150 is automatically generated in that format. If the user subsequently chooses to change to a different bibliography format, the bibliography generation module 126 will regenerate bibliography data 150 in the newly selected format.

In one embodiment, the word processing module 118 enables the user to customize a bibliography or citation format. The user can then select to utilize one or more custom bibliography or citation formats. The bibliography generation module 126 will then generates bibliography data in the selected custom format.

In one embodiment, the bibliography data 150 can include superscript reference numbers in the text of the word processing module, footnotes include that the foot of the page, and notes included at the end of the chapter, and notes included at the end of a document, and notes included at the end of the book, lists of citation references included in alphabetical order, list of citation references included in the order in which they appear in the research document, or other types of citation formats in accordance with the format selected by the user. Because the bibliography generation module 118 utilizes the reference metadata 158 to automatically generate the bibliography data 150, the user is spared from the error-prone and tedious process of generating a bibliography. Furthermore, the user does not need to use a first application to generate the research document, a second application to perform searches for references among databases, and a third application to assist in generating bibliography data 150. Instead, the research assistance application implemented by the research assistance system 112 incorporates all these functions into a single application which streamlines the process and reduces the potential for errors.

In one embodiment, the research assistance system 112 includes a speech recognition module 132. The speech recognition module 132 enables the user to include text in the research document data 148 by merely speaking. As the user speaks words to be included into the research document data 148, the speech recognition module 134 records and analyzes the speech of the user at generate speech transcription data 166. The speech transcription data 166 includes the words other by the user.

In one embodiment, the speech recognition module 134 enables the user to quickly record ideas that the user may have while not editing the document. For example, if the user is performing a household task and the user has an idea for something to be included in the research document, the user can access the research assistance application from the user's phone and can dictate the idea into the research assistance application. The research assistance application can record and transcribe speech. The transcribed speech can be placed into the research document, or into a list of personal notes of the user. If the transcribed speech is placed into a list of personal notes, then the user can refer to the transcribed speech at a later time in order to perform research or adjust the research document in accordance with the idea of the user.

In one embodiment, the research assistance system 112 includes an originality detection module 128. The originality detection module 128 can provide an indication to the user regarding how much of the research document is original material generated by the user. The originality detection module 120 can highlight for the user those parts of the research document that are not original material generated by the user. The user can add a revised material in order to increase an originality of the research document to a satisfactory level as determined by one or more of: the user, a teacher or professor of the user, a professional body to which the research document will be submitted, or other individuals or organizations.

In one embodiment, the originality detection module 120 generates document originality estimation data 160 estimating a percentage or portion of the research document that includes original material generated by the user. The document originality estimation data 160 can include a graphical presentation output via the GUI of the research assistance application indicating to the user the current originality score. The graphical presentation can include a percentage, a chart, a bar, a graph, or any other type of indicator that can inform the user of the current originality level of the research document. The graphical presentation can include a first color, for example red, if the originality score falls below a selected threshold. The graphical presentation can include a second color, for example green, if the originality score surpasses a selected direction. In this way the user can easily see whether or not the research document includes a satisfactory portion of original material generated by the user.

In one embodiment, the user gathers reference material to be included in the source pool 122. The user can then directly import reference material as quotes. Quoted material does not correspond to original material. In other cases, the user can discuss or critique in her own words some portion of the selected source material data 156. The originality detection module 128 analyzes such text in order to determine if the user's words correspond too closely to the wording of the selected source material that is being referred to but not quoted. The originality detection module 120 can highlight such text to indicate to the user that the user should choose different wording corresponding to the user's own ideas about the reference material, rather than wording corresponding to the words in the reference material itself. Thus, the originality detection module 128 can determine that unoriginal material corresponds to quoted text and text that too closely resembles text from the source material that is referred to or relied upon but is not directly quoted.

In one embodiment, a professor or faculty member can stipulate what percentage of a research document must correspond to originally generated material. The user will not be able to submit the research document until the research document as an originality score that satisfies the originality requirement.

In one embodiment, the originality detection module 128 includes a plagiarism detection module. In this case, the originality detection module 128 detects whether the user has plagiarized one or more sources. If the user has plagiarized the source by using material from the source but not citing the source, then the originality detection module 128 can inform the user that the research document includes text taken from a source but not cited. In one embodiment, the originality detection module 128 can search databases to determine if the research document includes text that has been imported from a non-cited document. In one embodiment, the research assistance system 112 interfaces with a third-party plagiarism detection service to perform plagiarism analysis.

In one embodiment, because the research assistance system 112 advantageously automatically attaches reference metadata 158 to source material imported into the source pool 122, it would be very difficult for a user to incorporate material into a research document without citing it. The research assistance application automatically generates citations which cannot be removed by the user, in one embodiment, when the user relies upon material from the source pool 122 in the research document.

In one embodiment, the research assistance system 112 stores the research document data 148, including any other data related to the research project, in a cloud computing environment. Thus, the user can access and edit the research document data 148 from multiple devices. The user can access and edit the research assistance application associated with the research assistance system 112 from a first computing device at a first time. At a second later time, the user can access and edit the research document from a second computing device. The progress is stored in the cloud, so the user can access and work on the research project from any computing device that can access the research assistance application.

In one embodiment, a group of users can collaborate in a research project to generate a research document utilizing the research assistance system 112. Each user can have access to the research document and can edit the research document. The research assistance system 112 keeps track of which portions of the research document were edited or contributed by which user. Each user can access the research assistance system 112 from a different computing device and can perform research, edit the document, add to the source pool 122, or monitor the progress the other users have made.

In one embodiment, a professor can assign a group of students to perform research and to generate a research document on a selected topic. The research assistance system 112 receives this information from the academic institution computing environments 180. When each student logs into the research assistance system 112, they will see the research project in their list of projects. They will also see the names of the other users that are assigned to the research project. They can select the research project and then contribute to the project and monitor the contributions of the other users. In one embodiment, the professor can see how the various members of the group contributed to the research project and can thereby evaluate and grade the performance of each student.

In one embodiment, when a research document is complete, the user can submit or output the research document via the research assistance system 112. The user can submit the research document to a professor, to a peer reviewing body, to an academic journal, to a publisher, to a website, or to other individuals and organizations.

In one embodiment, when a research document is complete, the research assistance system 112 can finalize the research document. Finalizing the research document can include saving the research document in a selected output file format. Alternatively, the research assistance system 112 can output the research document in a same file format in which the research document was edited and generated by the user. The research assistance system 112 can convert the research document to formats of other commonly used word processing or image viewing applications.

In one embodiment, the research document can include a genealogical document. A user or users can perform genealogical research via the search engine 120 among genealogical databases. The users can store selected source material from the genealogical databases in the source pool 122. The user can also capture or submit photographs of physical genealogical records for incorporation into the selected source material data 156 via the image capture module 130, the text recognition module 132, and the source metadata retrieval module 124.

In one embodiment, the research assistance system 112 includes a web browser. The user can utilize the web browser from within the research assistance application. The user can search for reference material via the web browser included in the research assistance application.

In one embodiment, the research assistance system 112 includes computing resources 136. The computing resources 136 include processing resources 165 and memory resources 167. The processing resources 165 include one or more processors. The memory resources 167 include one or more memories configured as computer readable media capable of storing software instructions and other data. The processing resources 164 are capable of executing software instructions stored on the computer readable media. In one embodiment, the various components, modules, databases, and engines of the training set labeling system 112 utilize the computing resources 136 to assist in performing their various functions. Alternatively, or additionally, the various components, modules, databases, and engines can utilize other computing resources. The computing resources 136 can include resources of the user computing environments 170 and computing resources remote from the user computing environments. The various modules can be stored and executed within the user computing environments, within computing environments remote from the user computing environments 170, or within both the user computing environments 170 and computing environments remote from the user computing environments.

In one embodiment, research assistance system can utilize the outline to generate slideshow files. For example, the research assistance system 112 can utilize the section headings and topic sentences in the outline of research document to generate slideshow presentations to be presented to others. Such slides so presentations could include, among other things, PowerPoint presentations or Google Slides presentations. The research assistance application 112 can automatically attach citations to the slides.

In one embodiment, the research assistance application can include Bluetooth connectivity enabling users to edit research documents with a Bluetooth keyboard, and Bluetooth mouse, a Bluetooth microphone, or other input devices. The research assistance application can include wireless connectivity other than Bluetooth connectivity to connect with input devices with wireless protocols other than Bluetooth.

In one embodiment, users can add images among the text of the research document. Users are able to select whether and how the text of the research document wraps around the image. The image can include its own citation which will be automatically included in the bibliography.

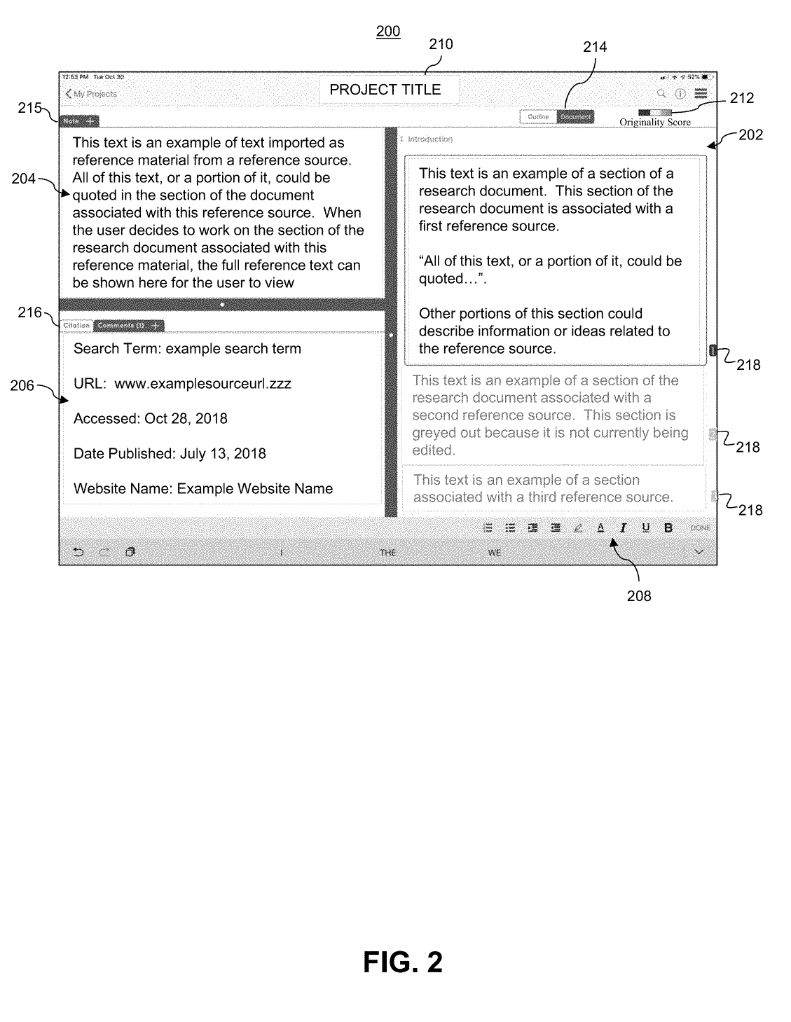

FIG. 2 is a view 200 of a GUI of a research assistance application provided by a research assistance system 112. The GUI includes a research document editing field 202, a source material viewing field 204, and a citation/comment viewing field 206, according to various embodiments. The GUI also includes word processing function icons 208, the project title 210, an originality score indicator 212, a document/outline toggle 214, an add note button 215, a citation/comments toggle 216, and reference citation indicators 218.

In one embodiment, in the research document editing field the user can create and edit the research document. The user can add text related to reference source material or quoted from reference source material in order to generate the research document. While editing the text of the research document, users can utilize the word processing function icons 208 to perform word processing tasks and to add word processing effects the text.

In one embodiment, the user can utilize the outline/document toggle 214 to toggle between a document view and an outline view in the research document editing field 202. If the user utilizes the toggle to select an outline view, then the view in the research document editing field 202 will switch to a view of the outline of the research document. From the outline view the user can view the various section topics of the research document and can edit, add, or remove sections or subsections from the outline. In one embodiment, when the user utilizes the document/outline toggle 214 to toggle back to a view of the research document, the user can then resume editing the text, images, graphics, or other data included in the research document.

In one embodiment, clicking between document text entries in the research document editing field 202 is an easy way to initiate a new web search or to add a note from one's own thoughts. The new note will automatically be placed in the outline in the location of the research document from which the new note was initiated.

In one embodiment, the research document is displayed in the editing field 202 in sections based on the research source material utilized for that section. When the user wishes to add a new section to the research document, the user can select the add note button 215. When the user clicks on the add note button 215, a dialog box pops up prompting the user to indicate whether the user would like to perform a new search, to add a new image, or to incorporate text from an image. If the user selects to perform a new search, a search query dialog box is opened, and the user can enter search terms. The user can also select one or more databases within which to perform the search. The search engine 120 then performs a search among the one or more selected databases and returns search results. When the user identifies material within the search results that the user would like to incorporate into the research document, the user can highlight the desired text and can then select to add the text of the note. This corresponds to adding the selected reference material to the source pool 122. The research assistance system 112 retrieves metadata related to the selected material, populates the notes field 204 with the selected material, and open to new section in the research document for the user to add text from the or to merely comment on the selected material. The research assistance system 212 also adds a citation indicator 218 to the section corresponding to that section to the source material. The citation data is generated or retrieved from the source metadata 158, and the citation field 206 is populated with the citation data. The user can view the citation data in the citation field 206, though the user cannot edit the citation data. Likewise, the user cannot edit the citation indicator 218. The research assistance system also automatically adds the citation data to the bibliography data 150.

In one embodiment, the section of the research document that is currently being edited is presented in black, while sections of the research document that are not being edited are presented in gray. By selecting a gray section, the gray section becomes black, indicating that the section is now in the process of being edited.

In one embodiment, the originality indicator 212 indicates the current originality score of the research document. In one example, sections highly lacking in original material can be indicated in red, sections somewhat lacking in original material can be indicated in yellow, and sections that are satisfactorily original can be displayed in green. Thus, the originality score indicator can indicate originality scores for individual sections and for the research document as a whole. Additionally, footnotes can be colored to represent levels of plagiarism relative to the text and the source note. Those of skill in the art will recognize, in light of the present disclosure, that an originality score can be indicated in many other ways.

In one embodiment, the user can utilize the citation/comments toggle 216 to toggle the citation field 206 between a view of the citation data, and a view of comments on the citation. When in the comments view, the user can select to add a new comment about the citation. The comment could include perceived relevance of the citation, how the user found the citation, or any other comments the user would like to add regarding the citation.

In one embodiment, the search term and the URL data in the citation data 216 are hyperlinked to source data. This allows users to quickly search for additional information related to previous searches.

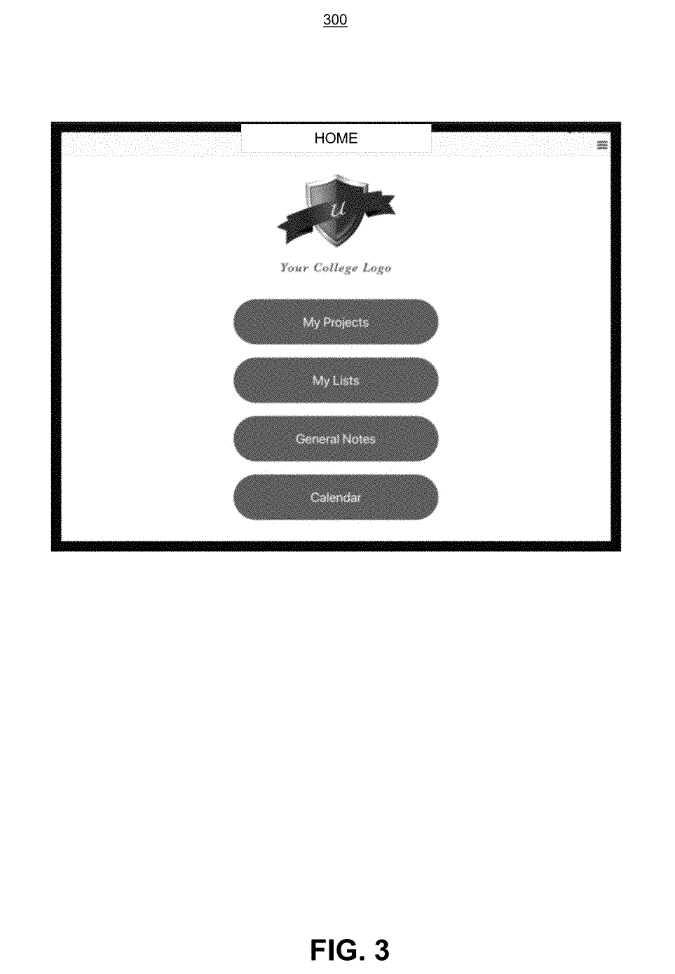

FIG. 3 is a view 300 of a home page of a research assistance application, according to one embodiment. The view 300 includes a projects button, a lists button, a general notes button, and a calendar button. By selecting the projects button, the user can ongoing projects in which the users involved. From the projects button, the user can also add new projects. Once the user has selected a project, the user may be brought to a view such as the view 200 shown in FIG. 2.

In one embodiment, if the user selects the lists button, the user is able to gather many types of notes and information into easily managed lists and outlines. The user can rate and sort notes or can outline sections, with to do action items and reminders. This can assist the user to manage information such as class notes, family histories, recipes, or business research and strategies.

In one embodiment, if the user selects the general notes button, the user can view and add general notes regarding projects lists, or other information.

In one embodiment, by selecting the calendar button, the user is able to view the user's calendar. The calendar can include class schedules, schedule meetings with collaborators, personal plans of the user, or other types of scheduling data.

In one embodiment, the research assistance system 112 is tied to an academic institution of the user. In this case, the academic institution can place a logo of the academic institution on the homepage and/or in other locations within the research assistance application.

Embodiments of the present disclosure address some of the shortcomings associated with traditional methods for performing research and generating research documents. A research assistance system in accordance with one or more embodiments enables users to perform research, manage sources and citations, and generate research documents all from a single research assistance application. A research assistance system in accordance with one or more embodiments greatly improves the efficiency with which individuals can perform research and generate research documents.

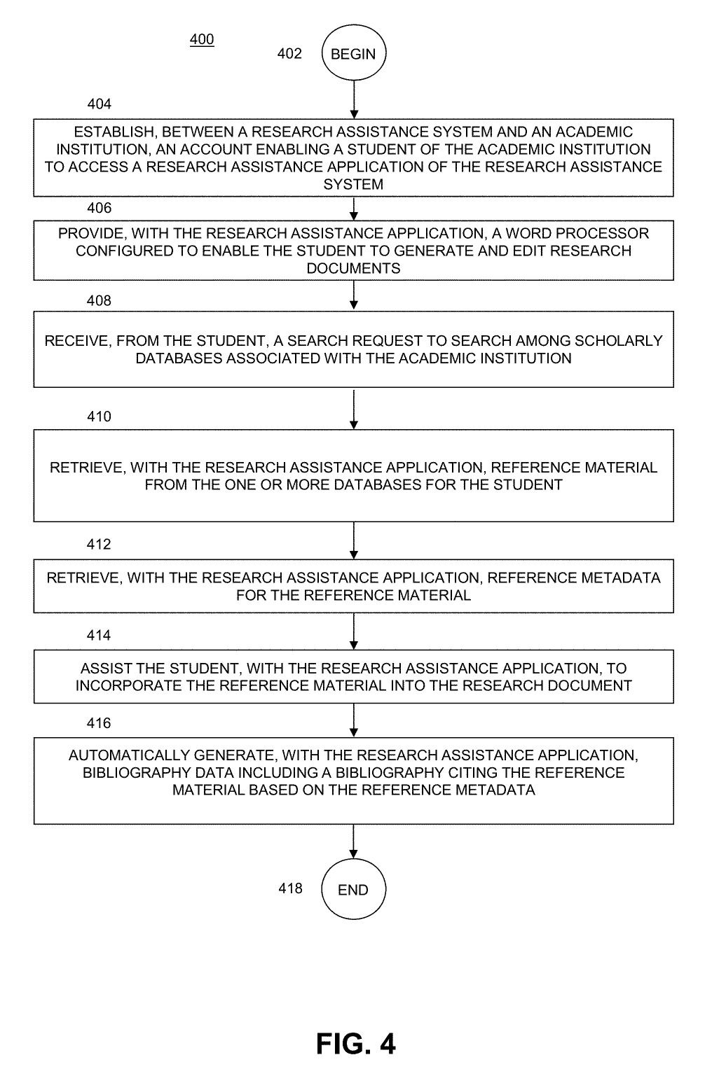

FIG. 4 illustrates a flow diagram of a process 400 for assisting researchers to perform research and generate research documents, according to various embodiments.

Referring to FIG. 4, FIGS. 1-3, and the description of FIGS. 1-3 above, in one embodiment, process 400 begins at BEGIN 402 and process flow proceeds to ESTABLISH, BETWEEN A RESEARCH ASSISTANCE SYSTEM AND AN ACADEMIC INSTITUTION, AN ACCOUNT ENABLING A STUDENT OF THE ACADEMIC INSTITUTION TO ACCESS A RESEARCH ASSISTANCE APPLICATION OF THE RESEARCH ASSISTANCE SYSTEM 404.

In one embodiment, at ESTABLISH, BETWEEN A RESEARCH ASSISTANCE SYSTEM AND AN ACADEMIC INSTITUTION, AN ACCOUNT ENABLING A STUDENT OF THE ACADEMIC INSTITUTION TO ACCESS A RESEARCH ASSISTANCE APPLICATION OF THE RESEARCH ASSISTANCE SYSTEM 404 a an account is established, between a research assistance system and an academic institution, enabling a student of the academic institution to access a research assistance application of the research assistance system, using any of the methods, processes, and procedures discussed above with respect to FIGS. 1-3.

In one embodiment, once an account is established, between a research assistance system and an academic institution, enabling a student of the academic institution to access a research assistance application of the research assistance system at ESTABLISH, BETWEEN A RESEARCH ASSISTANCE SYSTEM AND AN ACADEMIC INSTITUTION, AN ACCOUNT ENABLING A STUDENT OF THE ACADEMIC INSTITUTION TO ACCESS A RESEARCH ASSISTANCE APPLICATION OF THE RESEARCH ASSISTANCE SYSTEM 404 process flow proceeds to PROVIDE, WITH THE RESEARCH ASSISTANCE APPLICATION, A WORD PROCESSOR CONFIGURED TO ENABLE THE STUDENT TO GENERATE AND EDIT RESEARCH DOCUMENTS 406.

In one embodiment, at PROVIDE, WITH THE RESEARCH ASSISTANCE APPLICATION, A WORD PROCESSOR CONFIGURED TO ENABLE THE STUDENT TO GENERATE AND EDIT RESEARCH DOCUMENTS 406, a word processor is provided, with the research assistance application, configured to enable the student to generate and edit research documents, using any of the methods, processes, and procedures discussed above with respect to FIGS. 1-3.

In one embodiment, once a word processor is provided, with the research assistance application, configured to enable the student to generate and edit research documents at PROVIDE, WITH THE RESEARCH ASSISTANCE APPLICATION, A WORD PROCESSOR CONFIGURED TO ENABLE THE STUDENT TO GENERATE AND EDIT RESEARCH DOCUMENTS 406, process flow proceeds to RECEIVE, FROM THE STUDENT, A SEARCH REQUEST TO SEARCH AMONG SCHOLARLY DATABASES ASSOCIATED WITH THE ACADEMIC INSTITUTION 408.

In one embodiment, at RECEIVE, FROM THE STUDENT, A SEARCH REQUEST TO SEARCH AMONG SCHOLARLY DATABASES ASSOCIATED WITH THE ACADEMIC INSTITUTION 408, a search request is received, from the student, to search among scholarly databases associated with the academic institution, using any of the methods, processes, and procedures discussed above with respect to FIGS. 1-3.

In one embodiment, once a search request is received, from the student, to search among scholarly databases associated with the academic institution at RECEIVE, FROM THE STUDENT, A SEARCH REQUEST TO SEARCH AMONG SCHOLARLY DATABASES ASSOCIATED WITH THE ACADEMIC INSTITUTION 408, process flow proceeds to RETRIEVE, WITH THE RESEARCH ASSISTANCE APPLICATION, REFERENCE MATERIAL FROM THE ONE OR MORE DATABASES FOR THE STUDENT 410.

In one embodiment, at RETRIEVE, WITH THE RESEARCH ASSISTANCE APPLICATION, REFERENCE MATERIAL FROM THE ONE OR MORE DATABASES FOR THE STUDENT 410, reference material is retrieved, with the research assistance application, from the one or more databases for the student, using any of the methods, processes, and procedures discussed above with respect to FIGS. 1-3.

In one embodiment, once reference material is retrieved, with the research assistance application, from the one or more databases for the student at RETRIEVE, WITH THE RESEARCH ASSISTANCE APPLICATION, REFERENCE MATERIAL FROM THE ONE OR MORE DATABASES FOR THE STUDENT 410, process flow proceeds to RETRIEVE, WITH THE RESEARCH ASSISTANCE APPLICATION, REFERENCE METADATA FOR THE REFERENCE MATERIAL 412.

In one embodiment, at RETRIEVE, WITH THE RESEARCH ASSISTANCE APPLICATION, REFERENCE METADATA FOR THE REFERENCE MATERIAL 412, reference metadata is retrieved, with the research assistance application, for the reference material, using any of the methods, processes, and procedures discussed above with respect to FIGS. 1-3.

In one embodiment, once reference metadata is retrieved, with the research assistance application, for the reference material at RETRIEVE, WITH THE RESEARCH ASSISTANCE APPLICATION, REFERENCE METADATA FOR THE REFERENCE MATERIAL 412, process flow proceeds to ASSIST THE STUDENT, WITH THE RESEARCH ASSISTANCE APPLICATION, TO INCORPORATE THE REFERENCE MATERIAL INTO THE RESEARCH DOCUMENT 414.

In one embodiment, at ASSIST THE STUDENT, WITH THE RESEARCH ASSISTANCE APPLICATION, TO INCORPORATE THE REFERENCE MATERIAL INTO THE RESEARCH DOCUMENT 414, the student is assisted, with the research assistance application, to incorporate the reference material into the research document, using any of the methods, processes, and procedures discussed above with respect to FIGS. 1-3.

In one embodiment, once the student is assisted, with the research assistance application, to incorporate the reference material into the research document at ASSIST THE STUDENT, WITH THE RESEARCH ASSISTANCE APPLICATION, TO INCORPORATE THE REFERENCE MATERIAL INTO THE RESEARCH DOCUMENT 414, process flow proceeds to AUTOMATICALLY GENERATE, WITH THE RESEARCH ASSISTANCE APPLICATION, BIBLIOGRAPHY DATA INCLUDING A BIBLIOGRAPHY CITING THE REFERENCE MATERIAL BASED ON THE REFERENCE METADATA 416.

In one embodiment, at AUTOMATICALLY GENERATE, WITH THE RESEARCH ASSISTANCE APPLICATION, BIBLIOGRAPHY DATA INCLUDING A BIBLIOGRAPHY CITING THE REFERENCE MATERIAL BASED ON THE REFERENCE METADATA 416, bibliography data is automatically generated, with the research assistance application, including a bibliography citing the reference material based on the reference metadata, using any of the methods, processes, and procedures discussed above with respect to FIGS. 1-3.

In one embodiment, once bibliography data is automatically generated, with the research assistance application, including a bibliography citing the reference material based on the reference metadata at AUTOMATICALLY GENERATE, WITH THE RESEARCH ASSISTANCE APPLICATION, BIBLIOGRAPHY DATA INCLUDING A BIBLIOGRAPHY CITING THE REFERENCE MATERIAL BASED ON THE REFERENCE METADATA 416, process flow proceeds to END 418.

In one embodiment, at END 418 the process 400 for assisting researchers to perform research and generate research documents is exited to await new data and/or instructions.

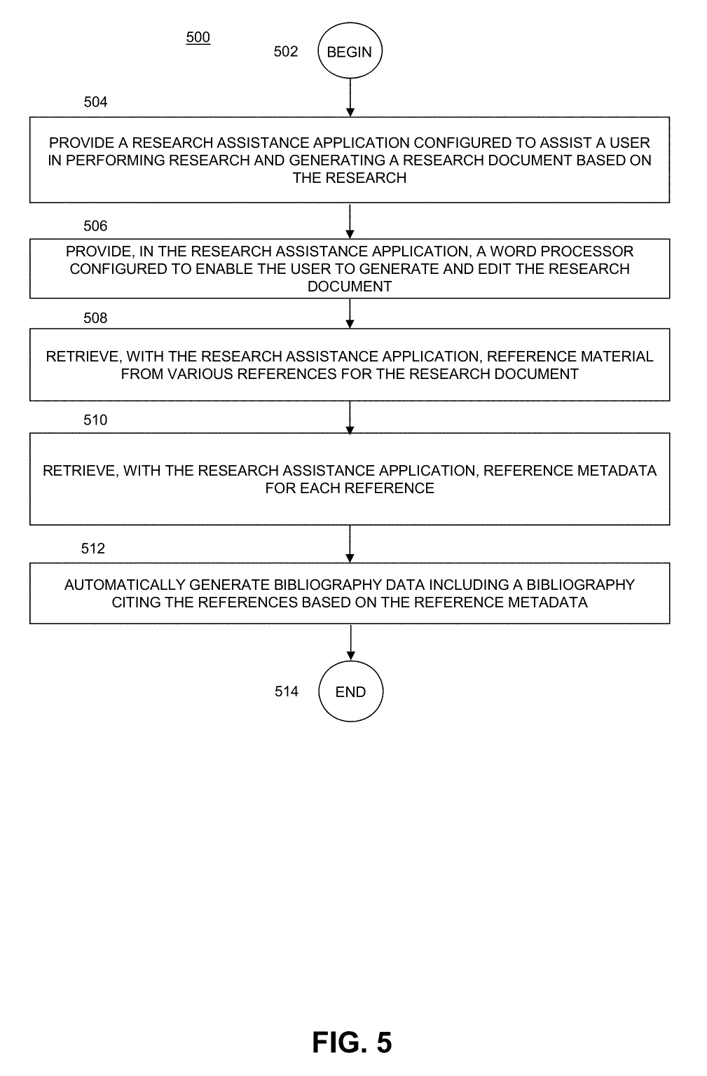

FIG. 5 illustrates a flow diagram of a process 500 for assisting researchers to perform research and generate research documents, according to various embodiments.

Referring to FIG. 5, FIGS. 1-3, and the description of FIGS. 1-3 above, in one embodiment, process 500 begins at BEGIN 502 and process flow proceeds to PROVIDE A RESEARCH ASSISTANCE APPLICATION CONFIGURED TO ASSIST A USER IN PERFORMING RESEARCH AND GENERATING A RESEARCH DOCUMENT BASED ON THE RESEARCH 504.

In one embodiment, at PROVIDE A RESEARCH ASSISTANCE APPLICATION CONFIGURED TO ASSIST A USER IN PERFORMING RESEARCH AND GENERATING A RESEARCH DOCUMENT BASED ON THE RESEARCH 504, a research assistance application is provided configured to assist a user in performing research and generating a research document based on the research, using any of the methods, processes, and procedures discussed above with respect to FIGS. 1-3.

In one embodiment, once a research assistance application is provided configured to assist a user in performing research and generating a research document based on the research at PROVIDE A RESEARCH ASSISTANCE APPLICATION CONFIGURED TO ASSIST A USER IN PERFORMING RESEARCH AND GENERATING A RESEARCH DOCUMENT BASED ON THE RESEARCH 504 process flow proceeds to PROVIDE, IN THE RESEARCH ASSISTANCE APPLICATION, A WORD PROCESSOR CONFIGURED TO ENABLE THE USER TO GENERATE AND EDIT THE RESEARCH DOCUMENT 506.

In one embodiment, at PROVIDE, IN THE RESEARCH ASSISTANCE APPLICATION, A WORD PROCESSOR CONFIGURED TO ENABLE THE USER TO GENERATE AND EDIT THE RESEARCH DOCUMENT 506, a word processor is provided, in the research assistance application, configured to enable the user to generate and edit the research document, using any of the methods, processes, and procedures discussed above with respect to FIGS. 1-3.

In one embodiment, once a word processor is provided, in the research assistance application, configured to enable the user to generate and edit the research document at PROVIDE, IN THE RESEARCH ASSISTANCE APPLICATION, A WORD PROCESSOR CONFIGURED TO ENABLE THE USER TO GENERATE AND EDIT THE RESEARCH DOCUMENT 506, process flow proceeds to RETRIEVE, WITH THE RESEARCH ASSISTANCE APPLICATION, REFERENCE MATERIAL FROM VARIOUS REFERENCES FOR THE RESEARCH DOCUMENT 508.

In one embodiment, at RETRIEVE, WITH THE RESEARCH ASSISTANCE APPLICATION, REFERENCE MATERIAL FROM VARIOUS REFERENCES FOR THE RESEARCH DOCUMENT 508, reference material is retrieved, with the research assistance application, from various references for the research document, using any of the methods, processes, and procedures discussed above with respect to FIGS. 1-3.

In one embodiment, once reference material is retrieved, with the research assistance application, from various references for the research document at RETRIEVE, WITH THE RESEARCH ASSISTANCE APPLICATION, REFERENCE MATERIAL FROM VARIOUS REFERENCES FOR THE RESEARCH DOCUMENT 508, process flow proceeds to RETRIEVE, WITH THE RESEARCH ASSISTANCE APPLICATION, REFERENCE METADATA FOR EACH REFERENCE 510.

In one embodiment, at RETRIEVE, WITH THE RESEARCH ASSISTANCE APPLICATION, REFERENCE METADATA FOR EACH REFERENCE 510, reference metadata is retrieved, with the research assistance application, for each reference, using any of the methods, processes, and procedures discussed above with respect to FIGS. 1-3.

In one embodiment, once reference metadata is retrieved, with the research assistance application, for each reference at RETRIEVE, WITH THE RESEARCH ASSISTANCE APPLICATION, REFERENCE METADATA FOR EACH REFERENCE 510, process flow proceeds to AUTOMATICALLY GENERATE BIBLIOGRAPHY DATA INCLUDING A BIBLIOGRAPHY CITING THE REFERENCES BASED ON THE REFERENCE METADATA 512.

In one embodiment, at AUTOMATICALLY GENERATE BIBLIOGRAPHY DATA INCLUDING A BIBLIOGRAPHY CITING THE REFERENCES BASED ON THE REFERENCE METADATA 512, a bibliography is automatically generated including a bibliography citing the references based on the reference metadata, using any of the methods, processes, and procedures discussed above with respect to FIGS. 1-3.

In one embodiment, once a bibliography is automatically generated including a bibliography citing the references based on the reference metadata

at AUTOMATICALLY GENERATE BIBLIOGRAPHY DATA INCLUDING A BIBLIOGRAPHY CITING THE REFERENCES BASED ON THE REFERENCE METADATA 512, process flow proceeds to END 514.

In one embodiment, at END 514 the process 500 for assisting researchers to perform research and generate research documents is exited to await new data and/or instructions.

As noted above, the specific illustrative examples discussed above are but illustrative examples of implementations of embodiments of the method or process for providing a tax refund confidence indicator to a user. Those of skill in the art will readily recognize that other implementations and embodiments are possible. Therefore, the discussion above should not be construed as a limitation on the claims provided below.

In one embodiment, a computing system implemented method for assisting researchers to perform research and generate research documents includes establishing, between a research assistance system and an academic institution, an account enabling a student of the academic institution to access a research assistance application of the research assistance system. The method includes providing, with the research assistance application, a word processor configured to enable the student to generate and edit research documents, receiving, from the student, a search request to search among scholarly databases associated with the academic institution, and retrieving, with the research assistance application, reference material from the one or more databases for the student. The method includes retrieving, with the research assistance application, reference metadata for the reference material, assisting the student, with the research assistance application, to incorporate the reference material into the research document, and automatically generating, with the research assistance application, bibliography data including a bibliography citing the reference material based on the reference metadata.

In one embodiment, a system for assisting researchers to perform research and generate research documents includes at least one processor and at least one memory coupled to the at least one processor. The at least one memory has stored therein instructions which, when executed by any set of the one or more processors provides a research assistance system that performs a process including establishing, between a research assistance system and an academic institution, an account enabling a student of the academic institution to access a research assistance application of the research assistance system. The process includes providing, with the research assistance application, a word processor configured to enable the student to generate and edit research documents, receiving, from the student, a search request to search among scholarly databases associated with the academic institution, and retrieving, with the research assistance application, reference material from the one or more databases for the student. The process includes retrieving, with the research assistance application, reference metadata for the reference material, assisting the student, with the research assistance application, to incorporate the reference material into the research document, and automatically generating, with the research assistance application, bibliography data including a bibliography citing the reference material based on the reference metadata.

In one embodiment, a computing system implemented method for assisting researchers to perform research and generate research documents includes providing a research assistance application configured to assist a user in performing research and generating a research document based on the research and providing, in the research assistance application, a word processor configured to enable the user to generate and edit the research document. The method includes retrieving, with the research assistance application, reference material from various references for the research document, retrieving, with the research assistance application, reference metadata for each reference, and automatically generating bibliography data including a bibliography citing the references based on the reference metadata.

In one embodiment, a system for assisting researchers to perform research and generate research documents includes at least one processor and at least one memory coupled to the at least one processor. The at least one memory has stored therein instructions which, when executed by any set of the one or more processors provides a research assistance system that performs a process including providing a research assistance application configured to assist a user in performing research and generating a research document based on the research and providing, in the research assistance application, a word processor configured to enable the user to generate and edit the research document. The process includes retrieving, with the research assistance application, reference material from various references for the research document, retrieving, with the research assistance application, reference metadata for each reference, and automatically generating bibliography data including a bibliography citing the references based on the reference metadata.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed tax return preparation system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the terms “interview” and “interview process” include, but are not limited to, an electronic, software-based, and/or automated delivery of multiple questions to a user and an electronic, software-based, and/or automated receipt of responses from the user to the questions, according to various embodiments.

As used herein, the terms messaging and messaging content include, but are not limited to, one or more of an advertisement, a banner advertisement, a message promoting a product or service, a self-help answer that includes a promotional message, and an email or text message sent to a customer or potential customer.

Embodiments of the present disclosure address some of the shortcomings associated with traditional research and document generation methods and processes. A research assistance system in accordance with one or more embodiments provides streamlined research, document generation, and bibliography generation processes. The various embodiments of the disclosure can be implemented to improve the technical fields of data processing, data transmission, data analysis, and data collection. Therefore, the various described embodiments of the disclosure and their associated benefits amount to significantly more than an abstract idea.

Using the disclosed embodiments of a method and system for assisting researchers to perform research and generate research documents, a method and system for assisting researchers to perform research and generate research documents is provided. Therefore, the disclosed embodiments provide a technical solution to the long-standing technical problem of inability to streamline the process of performing research, generating research documents, and producing accurate bibliographies.

In addition, the disclosed embodiments of a method and system for assisting researchers to perform research and generate research documents are also capable of dynamically adapting to constantly changing fields such as research and document generation. Consequently, the disclosed embodiments of a method and system for assisting researchers to perform research and generate research documents also provide a technical solution to the long-standing technical problem of static and inflexible research and document generation methods.

The result is a much more accurate, adaptable, and robust method and system for assisting researchers to perform research and generate research documents. This, in turn, results in: less human and processor resources being dedicated to performing research, maintaining sources, and generating a bibliography because more accurate and efficient analysis methods can be implemented, i.e., usage of fewer processing resources, usage of fewer memory storage assets, and less communication bandwidth being utilized to transmit data for analysis and consumption.

The disclosed method and system for assisting researchers to perform research and generate research documents does not encompass, embody, or preclude other forms of innovation in the area of electronic research assistance systems. In addition, the disclosed method and system for assisting researchers to perform research and generate research documents is not related to any fundamental economic practice, fundamental data processing practice, mental steps, or pen and paper-based solutions, and is, in fact, directed to providing solutions to new and existing problems associated with electronic research assistance systems. Consequently, the disclosed method and system for assisting researchers to perform research and generate research documents, does not encompass, and is not merely, an abstract idea or concept.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for assisting researchers to perform research and generate research documents, the method comprising:
providing a research assistance application configured to assist a user in performing research and generating a research document based on the research;
providing, in the research assistance application, a word processor configured to enable the user to generate and edit the research document;
retrieving, with the research assistance application, reference material from various references for the research document;
retrieving, with the research assistance application, reference metadata for each reference; and
automatically generating bibliography data including a bibliography citing the references based on the reference metadata.

2. The method of claim 1, wherein retrieving reference material includes:
receiving search query data from the user including one or more search terms;
searching, with a search engine of the research assistance application, among one or more databases in accordance with the search queries;
returning, with the search engine, search results data including one or more references related to the search queries;
enabling the user, in the research assistance application, to navigate among the search results data and to select reference material from one or more of the references.

3. The method of claim 2, wherein one of the references is a book and the source material from the book includes text from a page of the book, and wherein the reference metadata includes one or more of:
a title of the book;
an identification number of the book;
an author of the book;
the page number associated with the source material from the book;
an edition of the book;
a cover type of the book; and
a publisher of the book.

4. The method of claim 2, wherein one of the references is a website, and wherein the reference metadata includes one or more of:
a URL of the website;
a search term based on which the search engine found the website;
a date on which the source material was retrieved from the website by the research assistance application; and
a name of an individual or organization associated with the website.

5. The method of claim 2, wherein one of the references is a journal article, and wherein the reference metadata includes one or more of:
names of one or more authors of the journal article;
a name of the journal;
a title of the journal article;
a publication date of the journal article;
an edition of the journal in which the journal article was published; and
a page number on which the source material is located.

6. The method of claim 1, wherein receiving the reference material includes generating text data by analyzing an image of a reference with an optical character recognition process, wherein the reference material includes the text data.

7. The method of claim 6, further comprising receiving the image by interfacing, with the research assistance application, with a camera included in a computing device used by the user to access the research assistance application.

8. The method of claim 6, wherein retrieving the reference metadata includes:
analyzing one or more additional images of the reference with the optical character recognition process; and
retrieving information that identifies characteristics of the reference based on the optical character recognition process.

9. The method of claim 8, further comprising:
prompting the user to capture the one or more additional images; and
instructing the user to capture the one or more images to include identification information of the reference.

10. The method of claim 1, further comprising preventing the user from editing the bibliography data.

11. The method of claim 1, further comprising:
recording, with the research assistance application, audio data including speech of the user;
converting the audio data to text by performing, with the research assistance application, speech recognition analysis on the audio data; and
incorporating the text into the research document.

12. The method of claim 1, further comprising outputting the research document to a third party upon receiving a request from the user to output the research document to the third party.

13. The method of claim 1, wherein the research document includes one or more of:
a book;
an academic journal article;
a scientific journal article;
an academic presentation;
a magazine article;
a family history research document;
a school research paper;
a PhD dissertation; and
a master's thesis.

14. The method of claim 1, further comprising:
prompting the user to select a bibliography format; and
generating the bibliography data in accordance with the selected bibliography format.

15. A computing system implemented method for assisting researchers to perform research and generate research documents, the method comprising:
establishing, between a research assistance system and an academic institution, an account enabling a student of the academic institution to access a research assistance application of the research assistance system;
providing, with the research assistance application, a word processor configured to enable the student to generate and edit research documents;
receiving, from the student, a search request to search among scholarly databases associated with the academic institution;
retrieving, with the research assistance application, reference material from the one or more databases for the student;
retrieving, with the research assistance application, reference metadata for the reference material;
assisting the student, with the research assistance application, to incorporate the reference material into the research document; and
automatically generating, with the research assistance application, bibliography data including a bibliography citing the reference material based on the reference metadata.

16. The method of claim 15, further comprising:
receiving, with the research assistance application, academic course data related to academic courses of the student at the research institution; and
presenting, with the research assistance application, the academic course data to the student.

17. The method of claim 16, wherein the academic course data includes class schedule data of the student.

18. The method of claim 17, wherein the academic course data includes a research paper assignment assigned to the student by a faculty member of the research institution.

19. The method of claim 18, further comprising establishing, with the research assistance application, a research project to complete the research document in accordance with the research paper assignment.

20. The method of claim 19, further comprising:
monitoring, with the research assistance application, progress of the student in preparing the research document; and
providing, with the research assistance system, information to the faculty member.

21. The method of claim 19, further comprising submitting, with the research assistance application, the research document to the faculty member upon completion of the research document by the student.

22. A system for assisting researchers to perform research and generate research documents, the system comprising:
at least one processor; and
at least one memory coupled to the at least one processor, the at least one memory having stored therein instructions which, when executed by any set of the one or more processors provides a research assistance system that performs a process including:
providing a research assistance application configured to assist a user in performing research and generating a research document based on the research;
providing, in the research assistance application, a word processor configured to enable the user to generate and edit the research document;
retrieving, with the research assistance application, reference material from various references for the research document;
retrieving, with the research assistance application, reference metadata for each reference; and
automatically generating bibliography data including a bibliography citing the references based on the reference metadata.

23. The system of claim 22, wherein the process further includes:
storing the research document and the reference material data in cloud computing storage;
enabling the user to access the research assistance application from multiple computing devices; and
retrieving the research document from the cloud storage when the user accesses the research assistance application to edit the research document.

24. The system of claim 22, wherein the process further includes:
storing the research document and the reference material data in cloud computing storage;
enabling multiple users of the research assistance application to collaborate in performing research and generating the research document;
retrieving the research document from the cloud storage when one of the users accesses the research assistance application to edit the research document.

25. The system of claim 24, wherein the process further includes:
tracking, with the research assistance application, the contributions made by each user in generating the research document; and
enabling the users to see how each of the users has contributed to the research document.

26. The system of claim 22, wherein the process further includes automatically updating the bibliography data as the user adds reference material to the document, removes reference material from the research document, or rearranges the research document.

27. The system of claim 22, wherein the process includes executing the research assistance application in a computing device of the user.

28. The system of claim 27, wherein the computing device includes one or more of:
a smart phone;
a tablet;
a laptop computer; and
a desktop computer.

29. The system of claim 27, wherein the process includes executing portions of the research assistance application in a cloud computing environment remote from the computing device of the user.

30. The system of claim 27, wherein the research assistance application includes application programming interfaces that enable the research assistance application to interface with third party graphical design tool websites or systems.

31. The system of claim 22, wherein the process further includes generating an originality score for the research document indicating how much of the research document is material generated by the user.
